(19) United States
(12) Patent Application Publication
(10) Pub. No.: US 2002/0131792 A1
(43) Pub. Date: Sep. 19, 2002

(54) Process cartridge, image forming apparatus and image forming system

(75) Inventor: Yoshiya Nomura, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/091,286

(22) Filed: Mar. 6, 2002

(30) Foreign Application Priority Data
Mar. 9, 2001 (JP) 066965/2001
Feb. 21, 2002 (JP) 044641/2002

(51) Int. Cl. G03G 15/00

(52) U.S. Cl. 399/118

(57) ABSTRACT

A process cartridge detachably attachable to the main body of an electrophotographic image forming apparatus having a laser beam applying member, a shutter for shutting off the optical path of a laser beam emitted from the laser beam applying member, a main body abutting portion for moving the shutter to a retracted position retracted from a shutting-off position for shutting off the optical path, a main body frame provided upstream of the shutter with respect to the attachment direction of the process cartridge, and an opening portion provided in the main body frame has an electrophotographic photosensitive drum, process means for acting on the electrophotographic photosensitive drum, and a cartridge abutting portion adapted, when the process cartridge is to be attached to the main body of an electrophotographic image forming apparatus functionally differing from the main body of the image forming apparatus, to abut against a main body frame provided on the main body of the functionally different image forming apparatus to thereby block the attachment of the process cartridge, and when the process cartridge is to be attached to the main body of the image forming apparatus, to pass through the opening portion and abut against the main body abutting portion to thereby move the shutter to the retracted position.

### BACKGROUND OF THE INVENTION Field of the Invention and Related Art

This invention relates to a process cartridge detachably attachable to the main body of an electrophotographic image forming apparatus, an image forming apparatus and an image forming system. Here, the process cartridge refers to electrifying means, developing means or cleaning means as process means and an electrophotographic photosensitive member integrally made into a cartridge which is made detachably attachable to the main body of the image forming apparatus. Or it refers to at least one of electrifying means, developing means and cleaning means as process means and an electrophotographic photosensitive member integrally made into a cartridge which is made detachably attachable to the main body of the image forming apparatus. Further, it refers to at least developing means as process means and an electrophotographic photosensitive member integrally made into a cartridge which is made detachably attachable to the main body of the image forming apparatus.

Also, the term “electrophotographic image forming apparatus” covers, for example, an electrophotographic copying machine, an electrophotographic printer (such as an LED printer or a laser beam printer), an electrophotographic facsimile apparatus and an electrophotographic word processor.

In an image forming apparatus using the electrophotographic image forming process, there has heretofore been adopted a process cartridge system in which an electrophotographic photosensitive member and process means for acting on the electrophotographic photosensitive member are integrally made into a cartridge which is made detachably attachable to the main body of the image forming apparatus. According to this process cartridge system, the maintenance of the apparatus can be done by a user himself without resort to a serviceman and therefore, the operability of the apparatus could be markedly improved. So, this process cartridge system is widely used in image forming apparatuses.

The developing apparatus of this process cartridge has a toner container which is a developer container for containing therein a toner which is a developer, and a developing chamber provided with a developing roller which is a developer carrying member. When the toner in the toner container is used up, the process cartridge need be interchanged with a new one.

Also, in recent years, the digitization of copying machines and the use of plain paper in facsimile have advanced and a laser beam printer, a copying machine and a facsimile apparatus are sometimes constituted by a common printer portion. Products having these common printers need have their functions changed a little depending on the ways of use of the respective products. For example, in the laser beam printer and copying machine, even if there is not the detection of the remaining amount of toner, the process cartridge can be interchanged at a point of time whereat the toner in the toner container has become null and an image has become thin or blurred, and this does not become a great impediment. In the facsimile apparatus, however, there is a way of use such as reception in the nighttime or the like and therefore, if the apparatus is left in a state in which the toner in the toner container is about to become null, a thin output which is illegible may be put out. Consequently, a toner remaining amount apparatus for detecting the remaining amount of toner is requisite. Also, many of copying machines digitized in recent years have also the fax function and in this case, the toner remaining amount detecting apparatus becomes necessary even in the copying machines.

The above-mentioned toner remaining amount detecting apparatus is provided with a metallic antenna rod provided in a path leading from the toner container to a developing roller in the developing chamber in parallelism to the lengthwise direction of the developing roller. A voltage is applied to between this antenna rod and the developing roller and the capacitance between the two is measured, whereby the remaining amount of toner can be detected. A predetermined threshold value is provided, and when the detected capacitance becomes lower than the threshold value, it can be known that the toner between the two is little, that is, the toner in the container is little. In this manner, changes in the capacitance are detected to thereby detect the exhaustion of the toner.

As regards process cartridges for use in a group of such products, the ones for use in the facsimile apparatuses need have the toner remaining amount detecting function attached thereto, and the ones for the others need not have the toner remaining amount detecting function. Therefore, two kinds of process cartridges had to be prepared. These two kinds of process cartridges must be non-interchangeable with each other. Therefore, it would occur to mind to provide convex and concave shapes on respective frames, and provide a concavity and a convexity at corresponding locations on the main body of the image forming apparatus.

### SUMMARY OF THE INVENTION

It is an object of the present invention to provide a process cartridge, an electrophotographic image forming apparatus and an electrophotographic image forming system which can obviate a process cartridge from being wrongly attached to the main body of a functionally different electrophotographic image forming apparatus.

It is another object of the present invention to provide a process cartridge, an electrophotographic image forming apparatus and an electrophotographic image forming system in which a cartridge abutting portion provided on a process cartridge has both of the function of moving a laser shutter to a retracted position for opening a laser optical path and the function of obviating the process cartridge from being wrongly attached to the main body of a functionally different image forming apparatus.

It is another object of the present invention to provide a process cartridge, an electrophotographic image forming apparatus and an electrophotographic image forming system provided with a cartridge abutting portion which enables an operator to visually confirm wrong attachment when he tries to attach a process cartridge to a functionally different electrophotographic image forming apparatus.

It is another object of the present invention to provide a process cartridge, an electrophotographic image forming apparatus and an electrophotographic image forming system which have realized non-interchangeability by a simple construction like a projection protruded upwardly from the cleaning frame of the process cartridge.

It is another object of the present invention to provide a process cartridge detachably attachable to the main body of an electrophotographic image forming apparatus having a laser beam applying member, a shutter for shutting off the optical path of a laser beam emitted from the laser beam applying member, a main body abutting portion for moving the shutter to a retracted position retracted from a shutting-off position for shutting off the optical path, a main body frame provided upstream of the shutter with respect to the attachment direction of the process cartridge, and an opening portion provided in the main body frame, the process cartridge having:

an electrophotographic photosensitive drum;

process means for acting on the electrophotographic photosensitive drum; and process cartridge abutting portion adapted, when the process cartridge is to be attached to the main body of an electrophotographic image forming apparatus functionally differing from the main body of the image forming apparatus, to abut against a main body frame provided on the main body of the functionally different image forming apparatus to thereby block the attachment of the process cartridge, and when the process cartridge is to be attached to the main body of the image forming apparatus, to pass through the opening portion and abut against the main body abutting portion to thereby move the shutter to the retracted position.

It is another object of the present invention to provide an electrophotographic image forming apparatus for permitting one of a plurality of process cartridges to be detachably attached thereto and forming an image on a recording medium, comprising:

(i) a laser beam applying member;

(ii) a shutter for shutting off the optical path of a laser beam emitted from the laser beam applying member;

(iii) a main body abutting portion for moving the shutter to a retracted position retracted from a position for shutting off the optical path;

(iv) a main body frame provided upstream of the shutter with respect to the attachment direction of the process cartridge;

(v) an opening portion provided in the main body frame;

(vi) a cleaning frame, an electrophotographic photosensitive drum supported by the cleaning frame, an exposure opening formed in the cleaning frame to apply the laser beam to the electrophotographic photosensitive drum, and a cartridge abutting portion protruding upwardly from the cleaning frame with the process cartridge attached to the main body of the apparatus, and provided on one end portion of the exposure opening in the axial direction of the photosensitive drum, the cartridge abutting portion being adapted, when the process cartridge is to be attached to the main body of an electrophotographic image forming apparatus functionally differing from the main body of the image forming apparatus, to abut against a main body frame provided on the functionally different main body to thereby block the attachment of the process cartridge, and when the process cartridge is to be attached to the main body, to pass through the opening portion and abut against the main body abutting portion, whereby when the process cartridge is attached to the main body, the corner and upper portion of the distal end of the cartridge abutting portion abuts against the main body abutting portion to thereby move the shutter to the retracted position; and

(vii) conveying means for conveying the recording medium.

It is another object of the present invention to provide an electrophotographic image forming system for attaching a process cartridge to the main body of an electrophotographic image forming apparatus, and forming an image on a recording medium, the main body of the image forming apparatus comprising:

a laser beam applying member;

a shutter for shutting off the optical path of a laser beam emitted from the laser beam applying member;

a main body abutting portion for moving the shutter to a retracted position refracted from a shutting-off position for shutting off the optical path;

a main body frame provided upstream of the shutter with respect to the attachment direction of the process cartridge;

an opening portion provided in the main body frame;

attaching means for detachably attaching the process cartridge; and

conveying means for conveying the recording medium;

the process cartridge comprising:

an electrophotographic photosensitive drum;

process means for acting on the electrophotographic photosensitive drum; and

a cartridge abutting portion adapted, when the process cartridge is to be attached to the main body of an electrophotographic image forming apparatus functionally differing from the main body of the image forming apparatus, to abut against a main body frame provided on the functionally different main body of the image forming apparatus to thereby block the attachment of the process cartridge, and when the process cartridge is to be attached to the main body of the image forming apparatus, to pass through the opening portion and abut against the main body abutting portion to thereby move the shutter to the retracted position;

wherein when the process cartridge is to be attached to the main body of the electrophotographic image forming apparatus functionally differing from the image forming apparatus, the main body frame provided on the functionally different main body of the image forming apparatus and the cartridge abutting portion abut against each other to thereby block the attachment of the process cartridge, and when the process cartridge is to be attached to the attaching means, the cartridge abutting portion passes through the opening portion and abuts against the main body abutting portion to thereby move the shutter to the retracted position.

### BRIEF DESCRIPTION OF THE DRAWINGS

Some embodiments of the present invention are shown in the drawings, wherein:

FIG. 1 is a longitudinal cross-sectional view of an image forming apparatus.

FIG. 2 is a longitudinal cross-sectional view of a process cartridge.

FIG. 3 is a longitudinal cross-sectional view of the process cartridge.

FIG. 4 is a longitudinal cross-sectional view for illustrating how to attach the process cartridge to the image forming apparatus.

FIG. 5 is a perspective view of a copying machine.

FIG. 6 is a perspective view of the copying machine.

FIG. 7 is a perspective view showing the interchange of the process cartridge of the copying machine.

FIG. 8 is a perspective view of a printer.

FIG. 9 is a perspective view of the process cartridge.

FIG. 10 is a perspective view of the process cartridge.

FIG. 11 is a perspective view of the cleaning frame of the process cartridge.

FIG. 12 is a perspective view illustrating how to insert an antenna rod into the developing frame of the process cartridge.

FIGS. 13 and 14 are enlarged longitudinal cross-sectional views illustrating how to attach the process cartridge to the image forming apparatus.

FIG. 15 shows the relation between the attachment of a process cartridge P and the attachment of a process cartridge E to a laser beam printer A.

FIG. 16 shows the relation between the attachment of the process cartridge P and the attachment of the process cartridge E to a copying machine B.

FIG. 17 is a longitudinal cross-sectional view showing the process cartridge P as it has been attached to an image forming apparatus A in the present invention.

FIG. 18 is a perspective view of a process cartridge Q used in another functionally different image forming apparatus.

### DESCRIPTION OF THE PREFERRED EMBODIMENTS

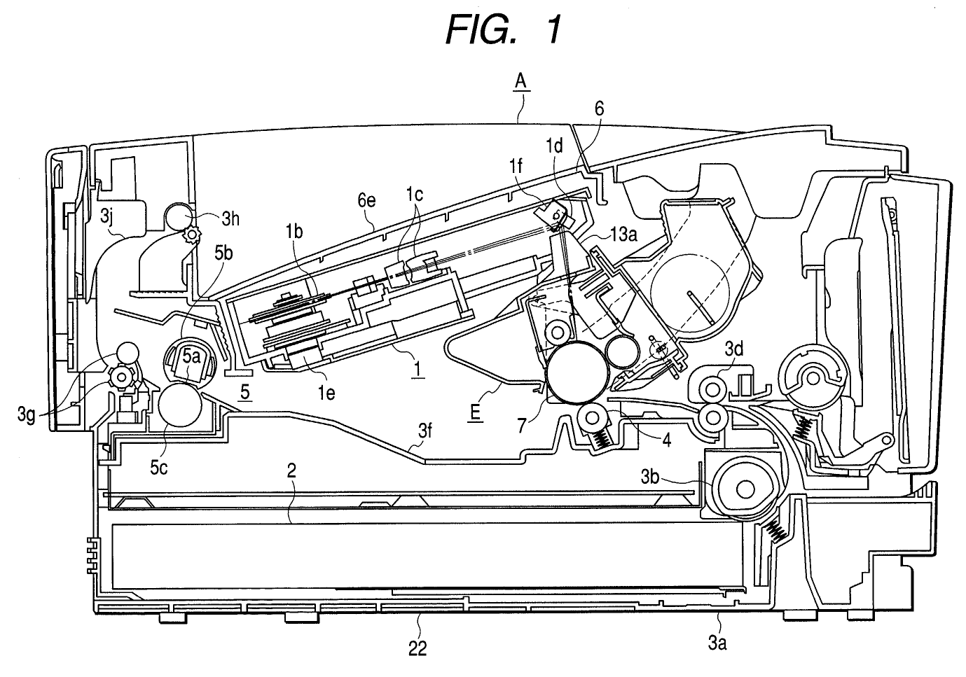

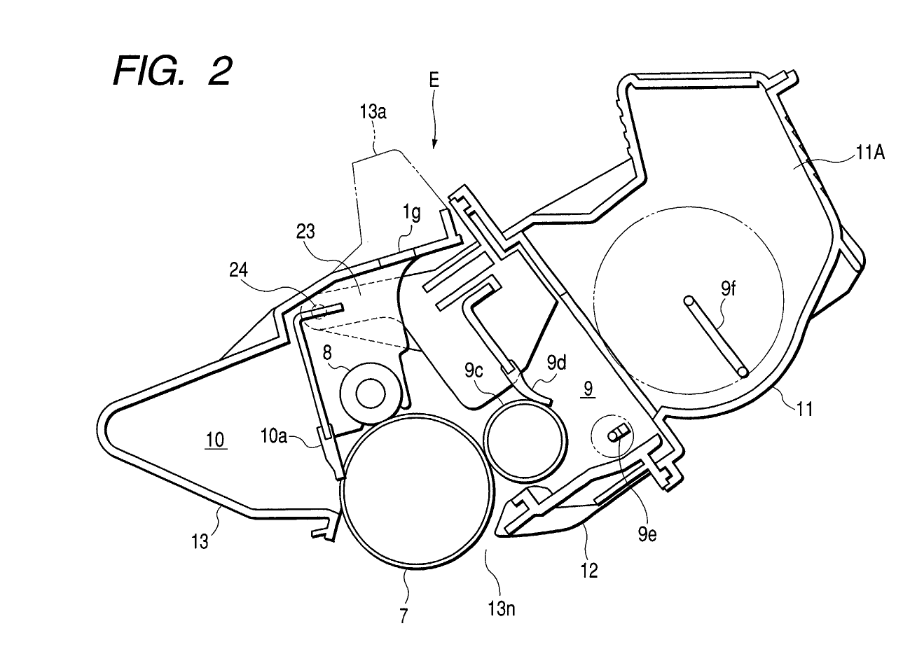

Reference is first had to FIGS. 1 and 2 to describe a laser beam printer A as an electrophotographic image forming apparatus to which Embodiment 1 of the present invention is applied.

This laser beam printer A, as shown in FIG. 1, forms an image on a recording medium (such as recording paper, an OHT sheet or cloth) by the electrophotographic image forming process. It forms a toner image on a drum-shaped electrophotographic photosensitive member (hereinafter referred to as the photosensitive drum). Specifically, electrification is effected on the photosensitive drum by electrifying means, and then a laser beam conforming to an image state is applied to the photosensitive drum to thereby form a latent image thereon. This latent image is then developed by developing means to thereby form a toner image. In synchronism with the formation of the toner image, a recording medium 2 set on a sheet feeding cassette 3a is reversal-conveyed by a pickup roller 3b and a pair of registration rollers 3d. The toner image formed on the photosensitive drum 7 of a process cartridge E is transferred to the recording medium 2 by a voltage being applied to a transferring roller 4 as transferring means. Thereafter, the recording medium 2 to which the toner image has been transferred is conveyed to fixing means 5 by a conveying guide 3f. This fixing means 5 has a driving roller 5c and a fixing rotary member 5b containing a heater 5a therein. Heat and pressure are applied to the recording medium 2 as it passes the fixing means 5, thereby fixing the transferred toner image. This recording medium 2 is conveyed by discharge rollers 3g and 3h and is discharged onto the sheet discharging tray 6e of a main body frame 6 through a reversing path 3j.

The optical means 1 is made into a unit as a laser scanner having a laser diode (not shown), a polygon mirror 1b, a lens 1c, a reversing mirror 1d and a scanner motor 1e. Also, the laser scanner 1 has a laser shutter 1f disposed at the exit of the laser beam. The laser shutter 1f is designed to be pivotally moved to two positions for intercepting and passing the laser beam.

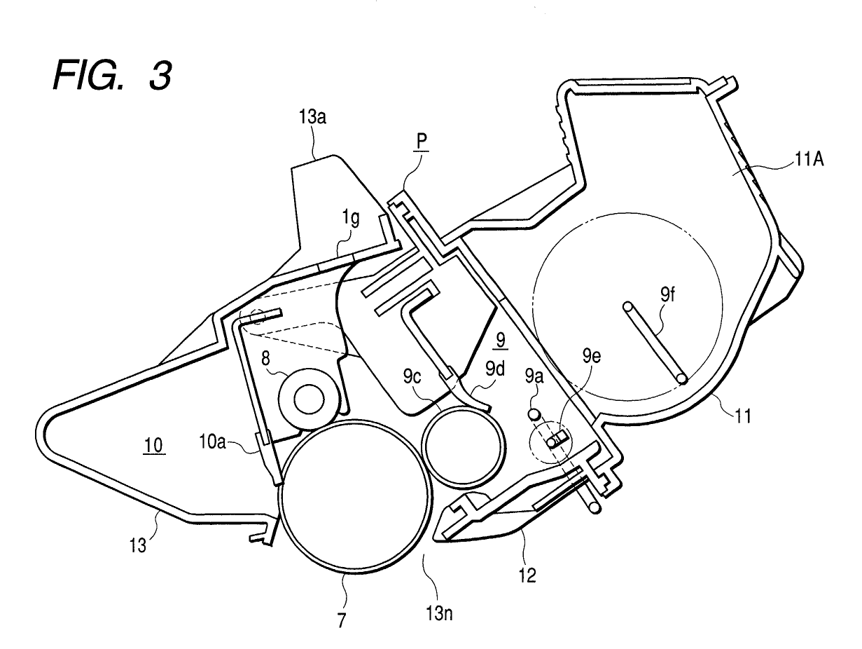

On the other hand, in the process cartridge E, as shown in FIGS. 2 and 3, the photosensitive drum 7 having a photosensitive layer is rotated and the surface thereof is uniformly electrified by the application of a voltage to an electrifying roller 8 which is electrifying means. A laser beam conforming to image information from the optical means 1 is applied to the photosensitive drum 7 through an exposure opening portion 1g to thereby form a latent image. This latent image is developed by developing means 9 by the use of a toner. That is, the electrifying roller 8 is provided in contact with the photosensitive drum 7 and effects electrification on the photosensitive drum 7. This electrifying roller 8 is driven to rotate by the photosensitive drum 7. Also, the developing means 9 supplies the toner to the developing area of the photosensitive drum 7 to thereby develop the latent image formed on the photosensitive drum 7.

The developing means 9 feeds the toner in a toner container 11A to a developing roller 9c by the rotation of a toner feeding member 9f. A developing roller 9c containing a stationary magnet therein is rotated and a toner layer having had triboelectrification charges induced therein by a developing blade 9d is formed on the developing roller, and that toner is shifted to the photosensitive drum 7 to thereby form a visible toner image. The developing blade 9d prescribes the amount of toner on the peripheral surface of the developing roller 9c and also induces triboelectrification charges. A toner agitating member 9e for circulating the toner in a developing chamber is rotatably mounted near the developing roller 9c.

The process cartridge E is constructed by coupling a toner frame (frame) 11 having a toner container (toner containing portion) 11A containing the toner therein and a developing frame (frame) 12 holding the developing means 9 such as the developing roller 9c to each other, and coupling thereto a cleaning frame (frame) 13 having attached thereto the photosensitive drum 7, cleaning means 10 such as a cleaning blade 10a, and the electrifying roller 8.

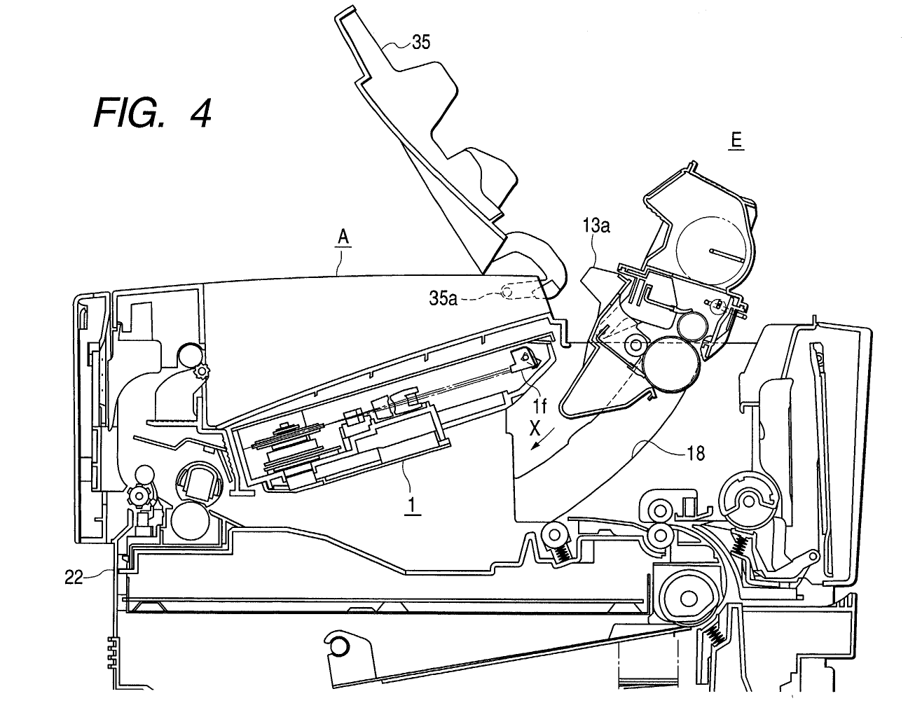

This process cartridge E is detachably attachable to the main body 22 of the image forming apparatus by an operator. The attachment and detachment of the process cartridge to and from the main body 22 of the image forming apparatus are accomplished by upwardly opening an openable and closable member 35 about a hinge 35a and attaching the process cartridge in the direction of arrow X in FIG. 4, and detaching it in a direction opposite to the direction of arrow X.

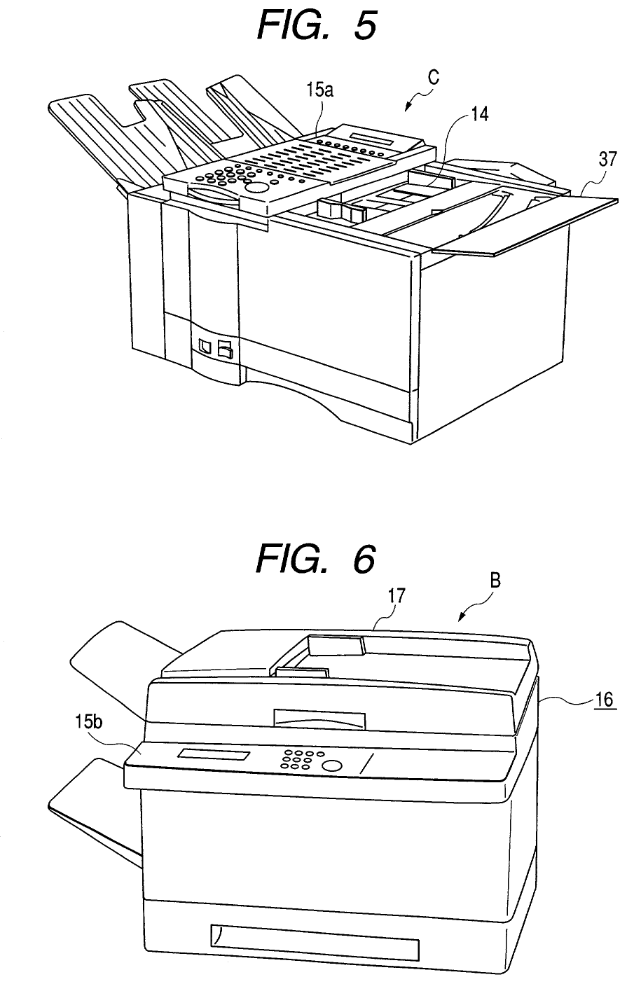

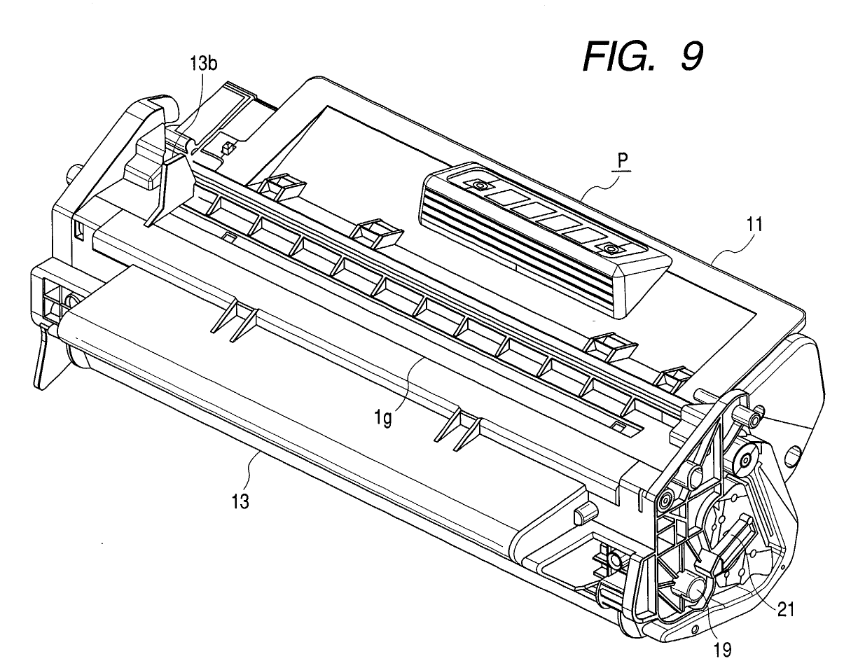

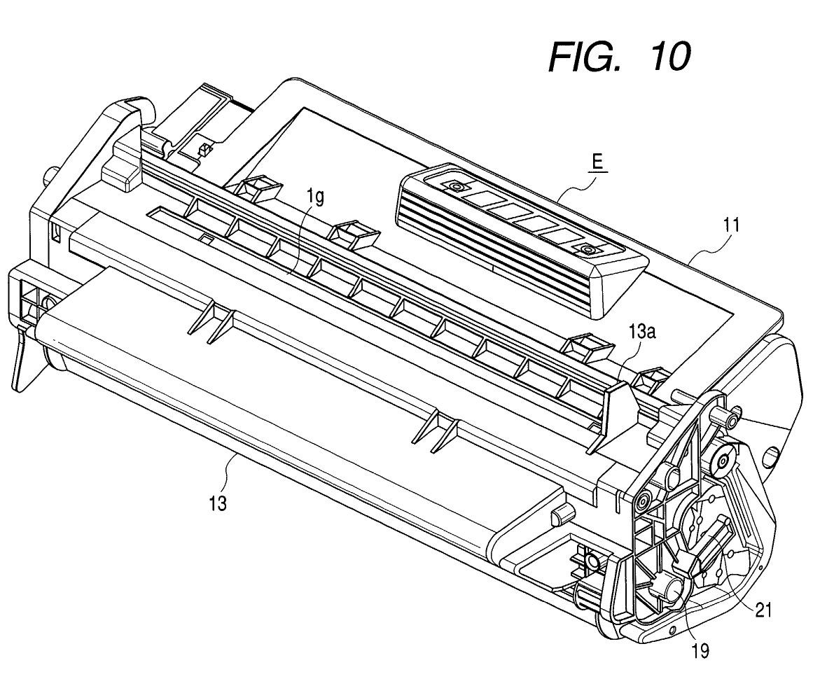

As shown in FIG. 4, guide members are disposed on the right and left inner walls of the main body of the apparatus as viewed in the attachment direction of the process cartridge, and a guide rail 18 is forwardly downwardly provided. On the other hand, as shown in FIGS. 9 and 10, the process cartridges P and E are the same except the locations of projections 13a and 13b, and a cylindrical positioning boss 19 is provided on the axis of the photosensitive drum 7. An elongate posture determining guide 21 is provided rearwardly of the boss 19 as viewed in the insertion direction of the process cartridges P and E. So, the positioning boss 19 and the posture determining guide 21 are fitted to the guide rail 18 to thereby attach or detach the process cartridges P and E to or from the main body of the apparatus. Such an attaching portion of the process cartridge is common to a facsimile apparatus C having a facsimile function in a laser beam printer shown in FIG. 5, a copying apparatus B shown in FIG. 6, and a laser beam printer A shown in FIG. 8, and a process cartridge having no projection for operating the laser shutter 1f could be attached to any of the image forming apparatuses A, B and C, but could not effect exposure.

The process cartridge E is provided with the exposure opening portion 1g for applying therethrough light conforming to the image information to the photosensitive drum 7, and a transfer opening portion 13n for opposing the photosensitive drum 7 to the recording medium 2. Specifically, the exposure opening portion 1g is provided in the cleaning frame 13. The projection 13a is disposed on one end portion (right end portion) of the exposure opening portion 1g in the axial direction of the photosensitive drum. The projection 13a is of a rib shape having a rectangular cross section. Also, the projection 13a is formed by being molded integrally with the cleaning frame 13.

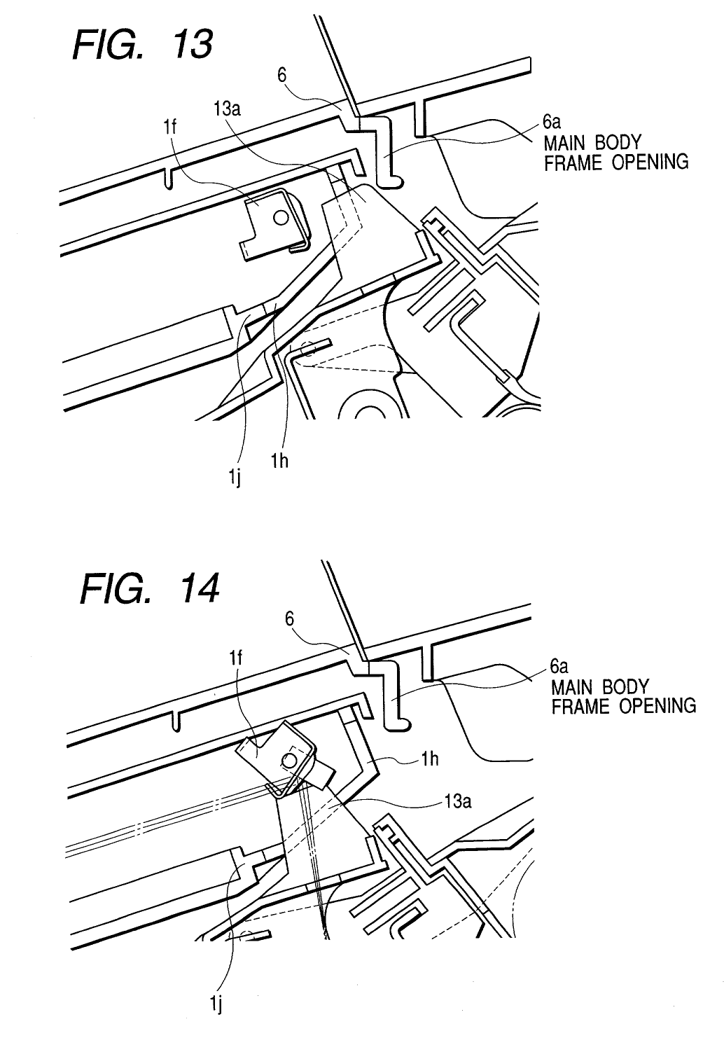

The process cartridge E as shown in FIG. 4, is attached to the main body 22 of the image forming apparatus from a direction (the direction of arrow X) intersecting with the axial direction of the electrophotographic photosensitive member. Next, as shown in FIG. 13, the projection 13a passes through an opening 6a in a main body formed at a location corresponding to the projection 13a provided on the process cartridge E, and an opening 1h in the frame of the laser scanner 1. An opening 22a in the main body frame and the opening 1h in the frame of the laser scanner 1 are narrow openings and prevent the malfunctioning or the like of the laser shutter 1f.

Further, as shown in FIG. 14, the corner portion and upper portion of the tip end of the projection 13a abut against the abutting portion 1fa of the laser shutter 1f to thereby move the laser shutter 1f to a retracted position for opening a laser optical path. As shown in FIG. 1, the process cartridge E is then attached to the main body of the image forming apparatus, and the laser beam becomes capable of being applied to the photosensitive drum 7.

Also, when the process cartridge E is pulled out, the laser shutter 1f is returned to a position for closing the optical path by the force of a spring (not shown) (the state of FIG. 4).

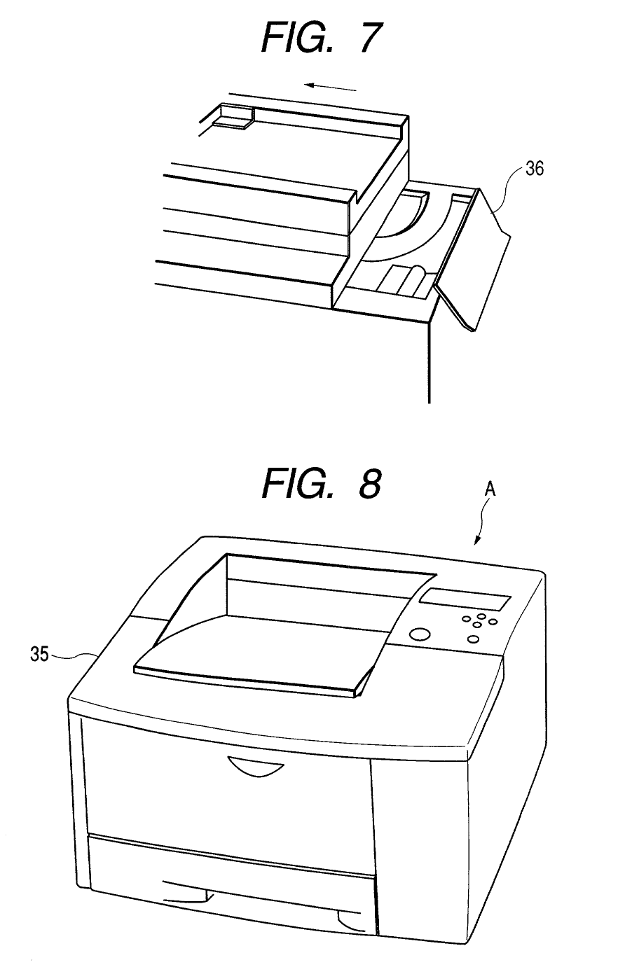

Now, as previously described, in recent years, it has often become the case that the image forming portions of a copying machine, a laser beam printer and a facsimile apparatus are made common to one another. By making them common, many merits such as the shortening of the period for developing products, improved reliability and the curtailment of cost are expected. The forms of an image forming apparatus according to the embodiment, as shown in FIGS. 5 to 8, include a facsimile apparatus C in which, with a laser beam printer A shown in FIG. 8 as a basic form, a sheet-through type original reading apparatus 14 and a control panel 15a are added to the upper portion as shown in FIG. 5, and which is provided with facsimile controlling means having the communicating function and a page memory therein, and a digital copying machine B in which as shown in FIG. 6, an original supporting type original reading apparatus 16, automatic original feeding means 17 and a control panel 15b are added to the upper portion and which is provided with control means for the copying machine therein. In the copying machine B, the attachment and detachment of the process cartridge P are effected by sliding the original reading apparatus 16 and the automatic original feeding means 17 in the upper portion in the direction of arrow as shown in FIG. 7 and opening an openable and closable member 36. Also, the attachment and detachment of the process cartridge of the facsimile apparatus C are effected by opening an openable and closable member 37.

The laser beam printer A does not have the toner remaining amount detecting function, while the copying machine B and the facsimile apparatus C have the toner remaining amount detection function set therein. Accordingly, it is necessary to prevent the copying machine B and the facsimile apparatus C from being wrongly mounted on the main body of the apparatus. Also, conversely, there is a case where it becomes necessary to make it impossible for the process cartridge P for the copying machine B to be attached to the main body of the laser beam printer A.

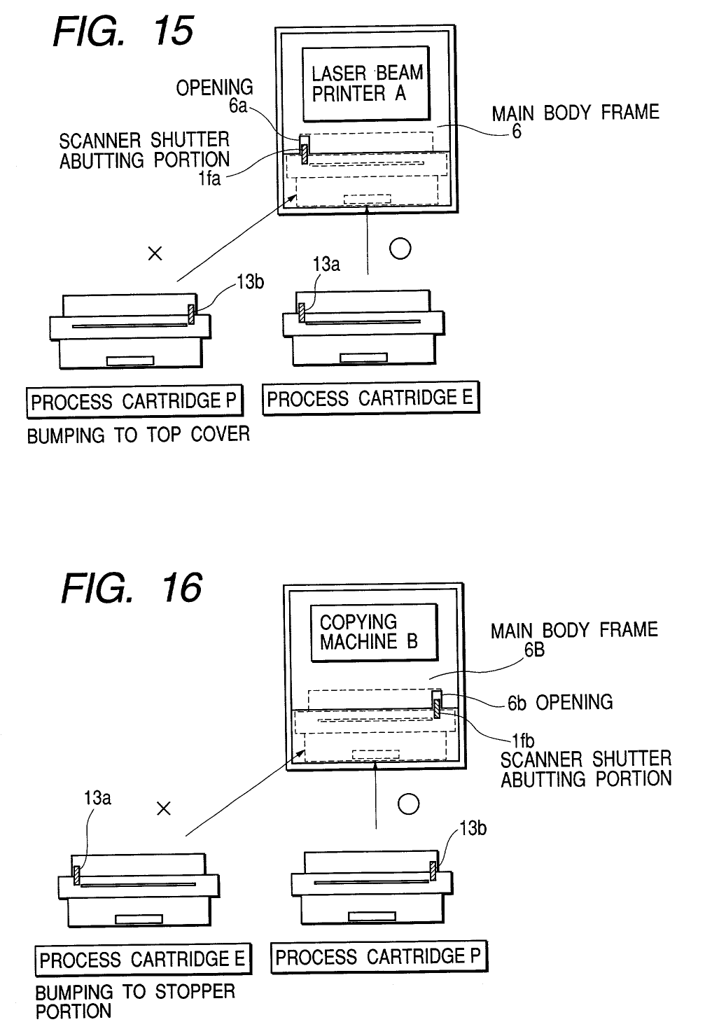

So, an abutting portion 1fb for pivotally moving the laser shutter of the laser scanner of the copying machine B is disposed at a location differing from that of the abutting portion 1fa of the laser beam printer A (FIGS. 15 and 16). Correspondingly, as shown in FIGS. 9 and 10, the projection 13b of the process cartridge P is disposed on the left side, and the projection 13a of the process cartridge E is disposed on the right side. This difference between the process cartridges E and P is apparently the difference between the locations of the projection 13a and the projection 13b, and that the process cartridge E does not have an antenna rod 9a for detecting the remaining amount of toner, but the process cartridge P has it mounted thereon as shown in FIG. 3. Consequently, when the process cartridge E is to be attached to the laser beam printer A, the projection 13a can pass through an opening 6a in the main body frame 6 and thus, the process cartridge E is attachable. However, when the process cartridge P is to be attached to the laser beam printer A, the projection 13b abuts against the main body frame 6 and the process cartridge P cannot be attached.

Also, when as shown in FIG. 16, an attempt is made to wrongly attach the process cartridge E to the copying machine B, the projection 13a bumps against the frame 6B of the copying machine B in the course of attachment and the process cartridge E cannot enter any further. So, the operator can visually confirm that the projection 13a has bumped against the frame 6B, and becomes aware that he has tried to attach a wrong process cartridge. Consequently, this is easier to detect an error than to make the operator aware of wrong insertion because of the openable and closable cover being not closable after the process cartridge E has been completely inserted. Further, according to the method of making the operator aware of wrong insertion because of the openable and closable cover being not closable, there is a risk that the operator, without knowing so, will try to forcibly close the openable and closable cover to thereby destroy a lock mechanism. Therefore, it will be necessary to make the lock mechanism and the openable and closable cover and the hinge thereof stoutly. The present invention is easy for the operator to know and therefore there is not the necessity thereof, and can realize non-interchangeability by a simple construction and further, can reduce the cost.

Also, the projection 13a also functions to move the laser shutter 1f to a retracted position for opening the laser optical path, and non-interchangeability can be realized by such a simple construction in which provision is made of the projection 13a protruded upwardly from the cleaning frame.

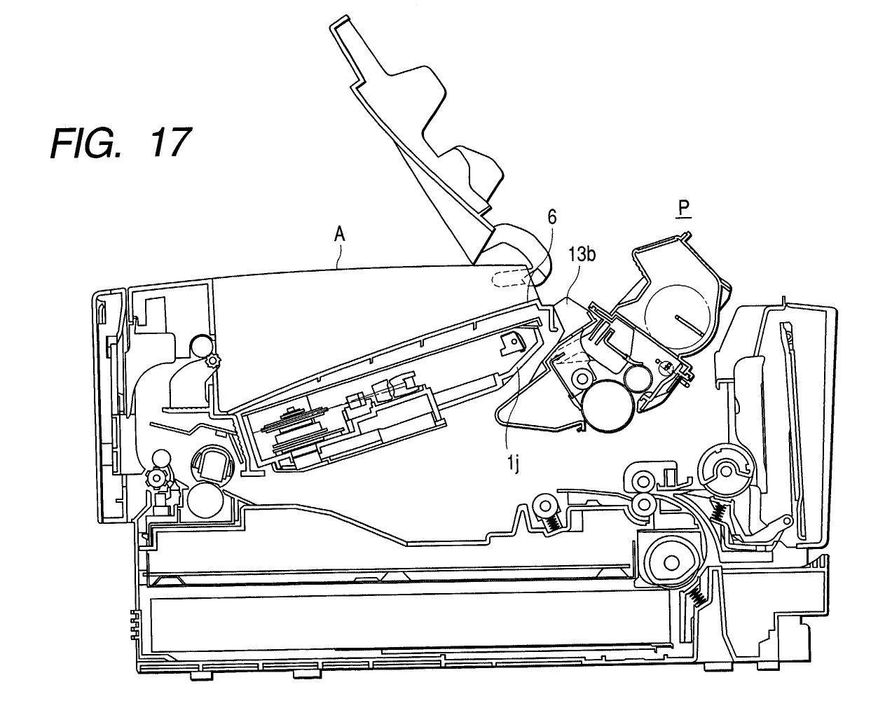

Also, in the present embodiment, if the operator attempts to wrongly attach the process cartridge P to the laser beam printer A, the projection 13b abuts against the main body frame 6, as shown in FIGS. 15 and 17, and the process cartridge P cannot be inserted any further. At this time, the operator can visually confirm that the projection 13b is abutting against the frame 6 and thus, quickly becomes aware that be has attached a wrong process cartridge. Also, this time, design is made such that the projection 13b abuts against the main body frame 6, but alternatively, design may be made such that the projection 13b abuts against a scanner frame 1j or other cover or the like.

In addition, in the main body of the image forming apparatus as well, it is not necessary to take the trouble to pre-mount a toner remaining amount detecting device which may lead to an increased cost, for example, on a laser beam printer which does not require the toner remaining amount detecting device for the purpose of making it common, and a reduction in cost can be achieved.

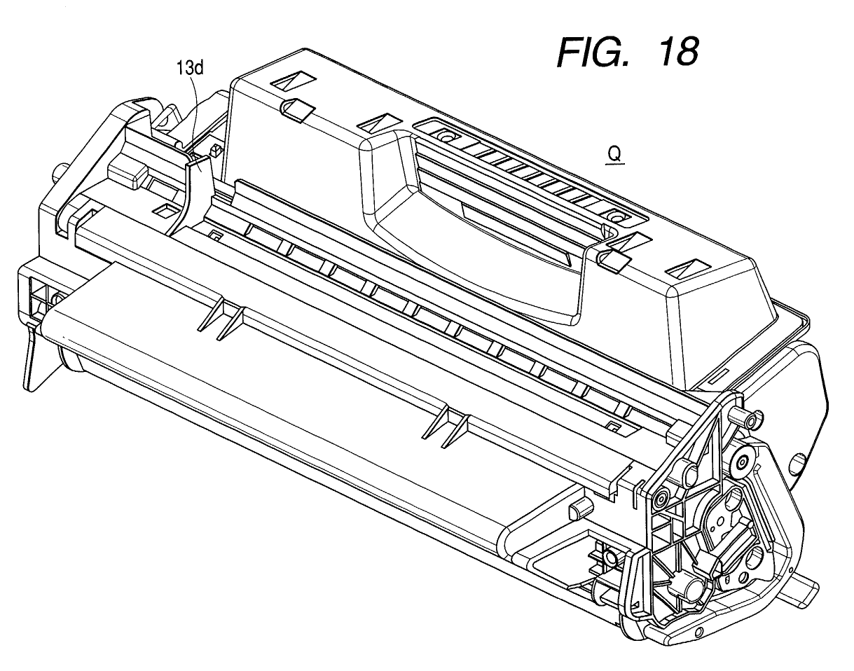

Also, this time, the projection 13a and the projection 13b are disposed at one end side and the other end side of the exposure opening 1g in the axial direction of the drum. However, when it becomes necessary to newly prevent a functionally different process cartridge from being attached, like a process cartridge Q shown in FIG. 18, a projection 13d can also provided at the same other end side of the exposure opening 1g in the axial direction of the drum as in the process cartridge P at a location differing from that of the projection 13b. Also, the projection 13a, the projection 13b and the projection 13d hiterto shown may be disposed at intervals from or astride the exposure opening from the relations of the necessary length of the exposure opening and the scanner shutter abutting position.

(Recycling Method for the Process Cartridge)

Description will now be made of a recycling method for the process cartridge according to the present invention. First, a used process cartridge is collected and assorted by kind. Next, the cleaning frame 13 supporting the photosensitive drum 7, the electrifying roller 8, the cleaning blade 10a, etc. is separated from the process cartridge, which is thus divided into the cleaning frame 13 and toner and developing units. This separation is effected by inserting arms 23 provided on the lengthwisely opposite ends of the developing frame 12 into the cleaning frame 13 and removing a pin 24 by which the frames 12 and 13 are engaged with each other.

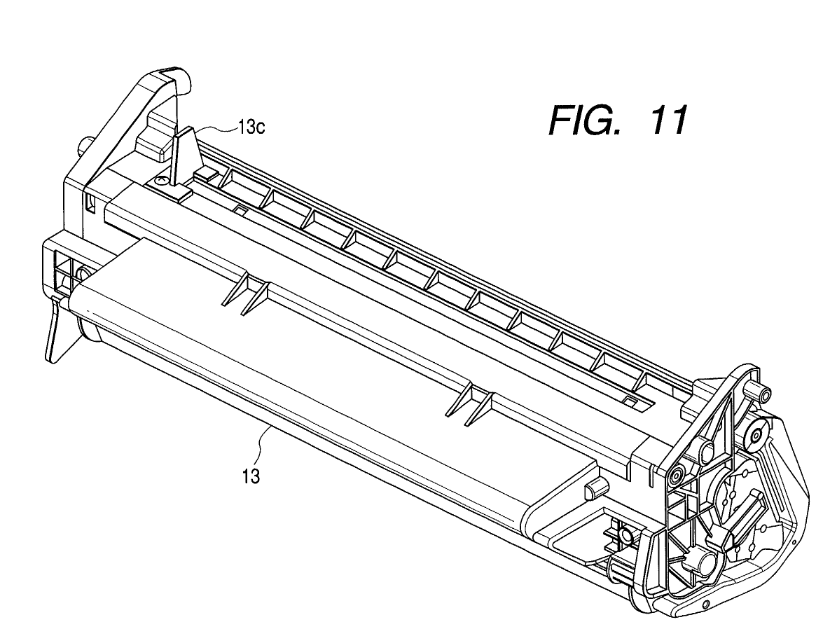

So, the photosensitive drum 7 and the cleaning blade 10a are first detached from the cleaning frame 13, and the removed toner therein is discarded, and the cleaning frame 13 cleaned. Next, as shown in FIG. 11, the projection 13a of the cleaning frame 13 is cut off, and a projected member 13c of the same shape as the cut-off projection is prepared and mounted at the same location as the location of the projection 13b of the process cartridge P as by screwing or heat caulking. Thereafter, a new cleaning blade and a new photosensitive drum 7 are mounted.

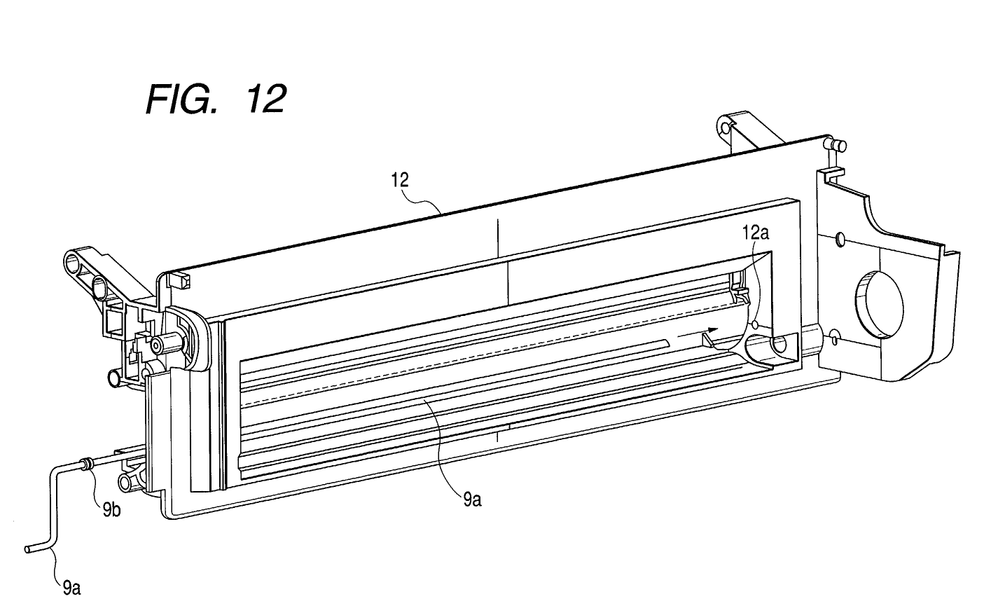

Next, the developing frame 12 and the toner frame 11 are cut and separated from each other. A seal member is stuck on the opening portion of the toner frame 11, which is thus re-sealed. A fresh toner is supplied through the toner supply port, not shown, of the toner frame 11, and then the toner supply port is sealed. Next, a seal member (not shown) made of woolen felt, elastomer or the like attached to a hole into which the antenna rod 9a for the detection of the remaining amount of toner present on the developing frame 12 is to be inserted is detached, and as shown in FIG. 12, the antenna rod 9a is inserted in the direction of arrow. A hole 12a for supporting the antenna rod 9a is pre-formed in an inner wall on the opposite side into which the antenna rod 9a of the developing frame 12 has been inserted, and the antenna rod 9a can be mounted by being simply inserted into the hole 12a. This hole 12a is a blind hole. At this time, a cylindrical seal member 9b made of ethylene, elastomer or the like is attached to the antenna rod 9a to seal the gap between the antenna rod 9a and the insertion hole 12a and is inserted together. Thereafter, the toner frame 11 and the developing frame 12 are re-coupled together by a coupling member such as a clip or means such as adhesive securing.

As described above, the developing frame 12 of the process cartridge E is also formed with a hole (not shown) for mounting the antenna rod 9a therethrough and a blind hole 12a. Thereby, the parts of two kinds of process cartridges can be made common to each other.

Lastly, the cleaning frame 13 on which the photosensitive drum 7, the cleaning blade 10a and the projecting member 13c have been newly mounted is united with the developing unit having the toner frame and the developing frame re-coupled together.

In this manner, the used process cartridge E for the laser beam printer A can be simply recycled into a process cartridge P for the copying machine. Also, when the converse recycling is to be done, the cutting-off of the projection 13b of the cleaning frame 13 and the attachment of the projected member 13c which is a discrete member can only be effected. The antenna rod 9a is mounted on the process cartridge P from first, but when the process cartridge P is to be used in the laser beam printer, it is affected in no way because there is no contact for receiving a signal from the antenna rod 9a on the main body side of the printer. Accordingly, there will be no problem even if the antenna rod 9a is left as it is.

The disassembling method and re-assembling method for the process cartridge described above are an example. As another method, there is included a case where the process cartridge is not disassembled, but is refilled through the toner supply port (if it is not exposed outside, it is provided with an aperture), and recycling in which the location of the projection for operating the laser shutter is changed when the process cartridge is to be made reusable is all included.

The aforedescribed embodiment includes a case where used process cartridges are collected and disassembled, and the same parts detached from the respective process cartridges by the disassembling are gathered, whereafter by the use of those parts, or in some cases, by the use of new parts (parts not reused) for some parts, the process cartridge is recycled by the aforedescribed recycling method. The aforedescribed embodiment also includes a case where used process cartridges are collected and disassembled, and by the use of parts detached from the cartridge, or in some cases, by the use of new parts (parts not reused) for some parts or parts detached from other process cartridges, the process cartridge is recycled by the aforedescribed recycling method.

As described above, the process cartridge E of the present embodiment is a process cartridge E detachably attachable to the main body A of an electrophotographic image forming apparatus having a laser beam applying member, a shutter 1f for intercepting the optical path of a laser beam emitted from the laser beam applying member, a main body abutting portion 1fa for moving the shutter 1f to a retracted position retracted from an intercepting position for intercepting the optical path, a main body frame 6 provided upstream of the shutter with respect to the attachment direction of the process cartridge, and an opening portion provided in the main body frame, the process cartridge E having:

an electrophotographic photosensitive drum 7;

process means for acting on the electrophotographic photosensitive drum; and

a cartridge abutting portion 13a adapted, when the process cartridge E is to be attached to the main body B of an electrophotographic image forming apparatus functionally differing from the main body A of the image forming apparatus, to abut against a main body frame 6B provided in the main body of the functionally different image forming apparatus to thereby block the attachment of the process cartridge, and when the process cartridge is to be attached to the main body A of the image forming apparatus, to pass through the opening portion 6a and abut against the main body abutting portion 1fa to thereby move the shutter 1f to the retracted position.

Also, according to the present embodiment, the projection 13a provided on the process cartridge E, when the process cartridge E is to be attached to the main body of an image forming apparatus (copying machine B) functionally differing from the main body of the image forming apparatus of a laser beam printer A, abuts against the main body frame 6B provided in the main body of the functionally different image forming apparatus. When the process cartridge is to be attached to the main body of the image forming apparatus of the laser beam printer A, the projection 13a passes through the opening portion 6a provided in the main body of the laser beam printer A and abuts against the abutting portion 1fa of the laser shutter 1f to thereby move the laser shutter 1f to the retracted position and open the optical path.

Consequently, the projection 13a can have both of the function of non-interchange and the function of abutting the abutting portion 1fa of the laser shutter 1f to thereby move the laser shutter 1f to the retracted position, and the use of a functionally different process cartridge and the attachment of the process cartridge to the main body of a functionally different image forming apparatus can be obviated by a simple construction.

Also, by the projection 13a being provided upwardly protrudedly from the cleaning frame at one end portion of the exposure opening 1g in the axial direction of the photosensitive drum 7, when the operator tries to wrongly attach the process cartridge E to a functionally different image forming apparatus, the projection 13a abuts against the main body B of the functionally different image forming apparatus at a visually confirmable position, whereby the operator can be quickly made aware of wrong attachment.

Consequently, as described above, the present invention can obviate a process cartridge from being wrongly attached to the main body of a functionally different electronic image forming apparatus. Also, the cartridge abutting portion provided on the process cartridge can have both of the function of moving the laser shutter to the retracted position for opening the laser optical path and the function of obviating the process cartridge from being wrongly attached to the main body of a functionally different image forming apparatus. Also, when the operator tries to attach a process cartridge to a functionally different electrophotographic image forming apparatus, the cartridge abutting portion abuts against a main body frame provided on the main body of the functionally different image forming apparatus to thereby enable the operator to visually confirm wrong attachment.

What is claimed is:

1. A process cartridge detachably attachable to the main body of an electrophotographic image forming apparatus having a laser beam applying member, a shutter for shutting off the optical path of a laser beam emitted from said laser beam applying member, a main body abutting portion for moving said shutter to a retracted position retracted from a shutting-off position for shutting off said optical path, a main body frame provided upstream of said shutter with respect to the attachment direction of the process cartridge, and an opening portion provided in said main body frame, said process cartridge having:
an electrophotographic photosensitive drum;
process means for acting on said electrophotographic photosensitive drum; and
a cartridge abutting portion adapted, when said process cartridge is to be attached to the main body of an electrophotographic image forming apparatus functionally differing from the main body of said image forming apparatus, to abut against a main body frame provided on the main body of said functionally different image forming apparatus to thereby block the attachment of said process cartridge, and when said process cartridge is to be attached to the main body of said image forming apparatus, to pass through said opening portion and abut against said main body abutting portion to thereby move said shutter to said retracted position.

2. A process cartridge according to claim 1, wherein said cartridge abutting portion is a projection protruding upwardly from the frame of said process cartridge in a state in which said process cartridge is attached to the main body of said image forming apparatus.

3. A process cartridge according to claim 1, wherein when said process cartridge is to be attached to the main body of the electrophotographic image forming apparatus functionally differing from the main body of said image forming apparatus, said cartridge abutting portion is provided at a location enabling a state in which the main body frame provided on the main body of said functionally different image forming apparatus and said cartridge abutting portion abut against each other to be visually confirmed.

4. A process cartridge according to claim 1, further having an exposure opening formed in the frame of said process cartridge to apply said laser beam therethrough to said electrophotographic photosensitive drum, and wherein said cartridge abutting portion is provided at one end side of said exposure opening in the axial direction of said electrophotographic photosensitive drum.

5. A process cartridge according to claim 1, further having an exposure opening formed in the frame of said process cartridge to apply said laser beam therethrough to said electrophotographic photosensitive drum, and wherein said cartridge abutting portion is provided at one end side of said exposure opening in the axial direction of said electrophotographic photosensitive drum at an interval from said exposure opening.

6. A process cartridge according to claim 4 or 5, wherein said cartridge abutting portion differs in disposition from a cartridge abutting portion provided on a process cartridge used in the main body of said functionally different image forming apparatus, and the cartridge abutting portion provided on the process cartridge used in the main body of said functionally different image forming apparatus is provided at the other end side of an exposure opening formed in the process cartridge used in the main body of said functionally different image forming apparatus.

7. A process cartridge according to claim 4 or 5, wherein said cartridge abutting portion differs in disposition from a cartridge abutting portion provided on a process cartridge used in the main body of said functionally different image forming apparatus, and the cartridge abutting portion provided on the process cartridge used in the main body of said functionally different image forming apparatus is provided at the other end side of an exposure opening formed in the process cartridge used in the main body of said functionally different image forming apparatus in the axial direction of the electrophotographic photosensitive drum at an interval from said exposure opening.

8. A process cartridge according to claim 4 or 5, wherein said cartridge abutting portion differs in disposition from a cartridge abutting portion provided on a process cartridge used in the main body of said functionally different image forming apparatus, and the cartridge abutting portion provided on the process cartridge used in the main body of said functionally different image forming apparatus is provided at one end side of said exposure opening in the axial direction of said electrophotographic photosensitive drum.

9. A process cartridge according to claim 4 or 5, wherein said cartridge abutting portion differs in disposition from a cartridge abutting portion provided on a process cartridge used in the main body of said functionally different image forming apparatus, and the cartridge abutting portion provided on the process cartridge used in the main body of said functionally different image forming apparatus is provided at one end side of said exposure opening in the axial direction of said electrophotographic photosensitive drum at an interval from said exposure opening.

10. An electrophotographic image forming apparatus for permitting a process cartridge to be detachably attached thereto and forming an image on a recording medium, comprising:
(i) a laser beam applying member;
(ii) a shutter for shutting off the optical path of a laser beam emitted from said laser beam applying member;
(iii) a main body abutting portion for moving said shutter to a retracted position from a shutting-off position for shutting off said optical path;
(iv) a main body frame provided upstream of said shutter with respect to the attachment direction of the process cartridge;
(v) an opening portion provided in said main body frame;
(vi) attaching means for detachably attaching a process cartridge having an electrophotographic photosensitive drum, process means for acting on said electrophotographic photosensitive drum, and a cartridge abutting portion adapted, when said process cartridge is to be attached to the main body of an electrophotographic image forming apparatus functionally differing from the main body of said image forming apparatus, to abut against a main body frame provided on said functionally different main body to thereby block the attachment of said process cartridge, and when said process cartridge is to be attached to said main body, to pass through said opening portion and abut against said main body abutting portion to thereby move said shutter to said retracted position; and
(vii) conveying means for conveying a recording medium.

11. An electrophotographic image forming system for attaching a process cartridge to the main body of an electrophotographic image forming apparatus, and forming an image on a recording medium, the main body of said image forming apparatus comprising:
a laser beam applying member;
a shutter for shutting off the optical path of a laser beam emitted from said laser beam applying member;
a main body abutting portion for moving said shutter to a retracted position retracted from a shutting-off position for shutting off said optical path;
a main body frame provided upstream of said shutter with respect to the attachment direction of the process cartridge;
an opening portion provided in said main body frame;
attaching means for detachably attaching said process cartridge; and
conveying means for conveying the recording medium;
said process cartridge having:
an electrophotographic photosensitive drum;
process means for acting on said electrophotographic photosensitive drum; and
a cartridge abutting portion adapted, when said process cartridge is to be attached to the main body of an electrophotographic image forming apparatus functionally differing from the main body of said image forming apparatus, to abut against a main body frame provided on the main body of said functionally different image forming apparatus to thereby block the attachment of said process cartridge, and when said process cartridge is to be attached to the main body of said image forming apparatus, to pass through said opening portion and abut against said main body abutting portion to thereby move said shutter to said retracted position;
wherein when said process cartridge is to be attached to the main body of the electrophotographic image forming apparatus functionally differing from the main body of said image forming apparatus, the main body frame provided on the main body of said functionally different image forming apparatus and said cartridge abutting portion abut against each other to thereby block the attachment of said process cartridge, and when said process cartridge is to be attached to the main body of said image forming apparatus, said cartridge abutting portion passes through said opening portion, and abuts against said main body abutting portion to thereby move said shutter to said retracted position.

12. An electrophotographic image forming system according to claim 11, wherein said cartridge abutting portion is a projection protruding upwardly from the frame of said process cartridge in a state in which said process cartridge is attached to the main body of said image forming apparatus.

13. An electrophotographic image forming system according to claim 11, wherein when said process cartridge is to be attached to the main body of the electrophotographic image forming apparatus functionally differing from the main body of said image forming apparatus, said cartridge abutting portion is provided at a location enabling a state in which the main body frame provided on the main body of said functionally different image forming apparatus and said cartridge abutting portion abut against each other to be visually confirmed.

14. An electrophotographic image forming system according to claim 11, wherein said process cartridge has an exposure opening formed in the frame of said process cartridge to apply said laser beam therethrough to said electrophotographic photosensitive drum, and said cartridge abutting portion is provided at one end side of said exposure opening in the axial direction of said electrophotographic photosensitive drum.

15. An electrophotographic image forming system according to claim 11, wherein said process cartridge has an exposure opening formed in the frame of said process cartridge to apply said laser beam therethrough to said electrophotographic photosensitive drum, and said cartridge abutting portion is provided at one end side of said exposure opening in the axial direction of said electrophotographic photosensitive drum at an interval from said exposure opening.

16. An electrophotographic image forming system according to claim 14 or 15, wherein said cartridge abutting portion differs in disposition from a cartridge abutting portion provided on a process cartridge used in the main body of said functionally different image forming apparatus, and the cartridge abutting portion provided on the process cartridge used in the main body of said functionally different image forming apparatus is provided at the other end side of an exposure opening formed in the process cartridge used in the main body of said functionally different image forming apparatus in the axial direction of the electrophotographic photosensitive drum.

17. An electrophotographic image forming system according to claim 14 or 15, wherein said cartridge abutting portion differs in disposition from a cartridge abutting portion provided on a process cartridge used in the main body of said functionally different image forming apparatus, and the cartridge abutting portion provided on the process cartridge used in the main body of said functionally different image forming apparatus is provided at the other end side of an exposure opening formed in the process cartridge used in the main body of said functionally different image forming apparatus in the axial direction of the electrophotographic photosensitive drum at an interval from said exposure opening.

18. An electrophotographic image forming system according to claim 14 or 15, wherein said cartridge abutting portion differs in disposition from a cartridge abutting portion provided on a process cartridge used in the main body of said functionally different image forming apparatus, and the cartridge abutting portion provided on the process cartridge used in the main body of said functionally different image forming apparatus is provided at one end side of said exposure opening in the axial direction of said electrophotographic photosensitive drum.

19. An electrophotographic image forming system according to claim 14 or 15, wherein said cartridge abutting portion differs in position from a cartridge abutting portion provided on a process cartridge used in the main body of said functionally different image forming apparatus, and the cartridge abutting portion provided on the process cartridge used in the main body of said functionally different image forming apparatus is provided at one end side of said exposure opening in the axial direction of said electrophotographic photosensitive drum at an interval from said exposure opening.

20. A process cartridge, an electrophotographic image forming apparatus or an electrophotographic image forming system according to claim 1, 10 or 11, wherein the main body of said image forming apparatus is an electrophotographic printer, and the main body of said functionally different image forming apparatus is an electrophotographic printer, an electrophotographic copying machine or an electrophotographic facsimile apparatus.
